(19) United States
(12) Patent Application Publication
(10) Pub. No.: US 2007/0214110 A1
(43) Pub. Date: Sep. 13, 2007

(54) Systems and methods for providing services

(75) Inventors: Jochen Guertler, Karlsruhe (DE); Oren Root, Kfar Ben-Nun (IL); Amir Glatt, Tel Aviv (IL)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(73) Assignee: SAP AG

(21) Appl. No.: 11/370,993

(22) Filed: Mar. 9, 2006

(51) Int. Cl. G06F 17/30

(52) U.S. Cl. 707/3

(57) ABSTRACT

Methods and apparatus, including computer program products, are provided for making a call from a user interface to a service. In one exemplary embodiment, the method may include determining metadata reflecting aspects of the user interface; providing a request to the service including metadata reflecting aspects of the user interface corresponding to presentation of responsive information; and receiving a response to the request from the service including the responsive information adapted in accordance with the metadata.

### FIELD

The present invention generally relates to data processing and, more particularly, to making calls from a client computer to a server using messages enhanced with metadata.

### BACKGROUND

Advances or changes in how enterprises conduct business result from, for example, growing competition and globalization, mergers and acquisition, or a revamping of business models. Successful advances and changes often depend on how quickly the enterprise's information technology (IT) organization adapts to evolving business needs.

For organizations to enable business advances and changes, they must ensure that enterprise applications are not only high-performance business engines driving efficiencies, but also that the applications become flexible building blocks of future business systems. Recently, building blocks have taken the form of “services.” A service, such as a Web service, may be implemented as a software application (also referred to as “application”) which may be called by another application to provide a service over a network, such as the Internet. A service represents a self-contained, self-describing piece of application (also referred to as a “program”) functionality that can be found and called by other applications. A service may be self-contained because the application calling the service does not have to depend on anything other than the service itself, and may be self-describing because all the information on how to use the service can be obtained from the service itself. To interact with a service, a client system may make a call, such as a Simple Object Access Protocol (SOAP) call, to the service. The call may include sending a message, such as a SOAP message formatted in accordance with a WSDL (Web Services Definition Language) document describing the service.

In some cases, the client system may include a user interface, such as a Web browser (also referred to as a browser), to present content from a portal (also referred to as a Web portal) at a server. A Web browser (e.g., Netscape Navigator™) is an application used to locate and present content, such as a Web page. A Web page (also referred to as a page) is a document generated for presentation by a browser. Often, a page is generated using code, such as a markup language like the Hyper Text Markup Language (HTML). A portal is an application that aggregates content from one or more services. The web site www.yahoo.com is an example of portal since it aggregates content from one or more services, such as e-mail, weather, stock quotes, searching, on-line shopping, and the like. The portal aggregates content by generating a Web page, which is provided to a browser for presentation.

The portal may include “portlets.” A portlet is an application (or component of an application) that processes requests for content and retrieves content. A portlet may retrieve content from a service and provide the content to the portal and/or the client. Java community standard JSR-168 titled, Portlet Specification (Final Release), 27 Oct. 2003 (available at jcp.org) describes an example of a portlet. Other examples have been implemented as well, including the software technology referred to as “iViews” (commercially available from SAP AG, Walldorf, Germany).

When portals and/or portlets are used, the client systems and/or portlets may frequently access services to gather information, which may result in frequent and, thus, burdensome message exchanges among the service, portlets, and client system. There is thus a need to reduce the volume of such message exchanges.

### SUMMARY

The present invention provides methods and apparatus, including computer program products, for making calls using messages enhanced with metadata.

In one exemplary embodiment, there is provided a method for making a call from a user interface to a service. The method may include determining metadata reflecting aspects of the user interface; providing a request to the service including metadata reflecting aspects of the user interface corresponding to presentation of responsive information; and receiving a response to the request from the service including the responsive information adapted in accordance with the metadata.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of implementations consistent with the present invention and, together with the description, help explain some of the principles associated with the invention. In the drawings,

FIG. 1A illustrates a block diagram of an exemplary system environment consistent with certain aspects related to the present invention;

FIG. 1B illustrates a flow chart with steps for sending metadata in a request message to a service consistent with certain aspects related to the present invention;

FIG. 2A depicts a block diagram of another exemplary system environment consistent with certain aspects related to the present invention;

FIG. 2B illustrates another flow chart with steps for sending metadata in a request message to a service consistent with certain aspects related to the present invention;

FIG. 3A depicts a block diagram of another exemplary system environment consistent with certain aspects related to the present invention; and

FIG. 3B illustrates a flow chart with steps for including metadata in a response message to a client system consistent with certain aspects related to the present invention.

### DETAILED DESCRIPTION

Reference will now be made in detail to the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

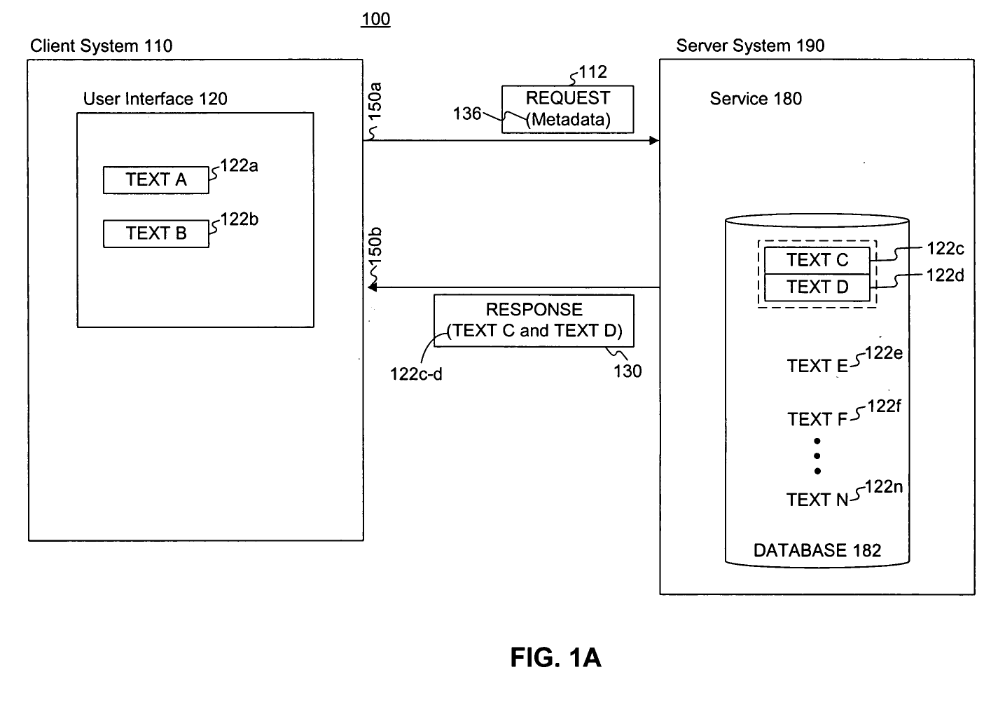

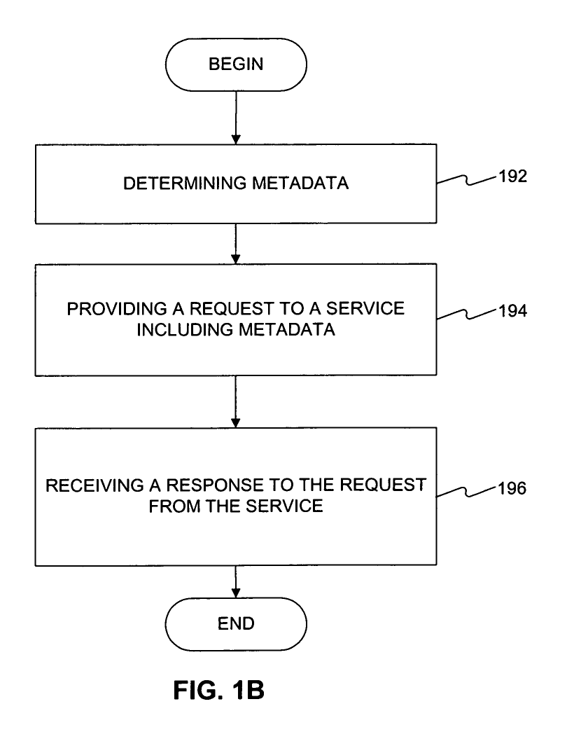

FIG. 1A is a block diagram of an exemplary system 100 environment that includes a client system 110 and a server system 190, with server system 190 further including a service 180. The client system 110 and server system 190 may each be implemented as one or more computers. Moreover, client system 110 may include a user interface 120 for presenting information associated with an interaction with an application or a service, such as a service 180. For example, service 180 may provide a sales order form to allow a user at user interface 120 to interact with (e.g., view, fill-out, and the like) the form. Although a service may be made available through the Internet, services may also be made available through an intranet or any other communication mechanism.

Client system 110 and/or user interface 120 may call, through network connection 150a, to request an interaction with service 180. For example, service 180 may include a database application 182 that can be searched by a user through user interface 120. In this example, user interface 120 calls service 180 to request a search of database application 182. Service 180 may then respond with a call through network connection 150b, with the call including information responsive to the request (e.g., the results of the search). User interface 120 may present content information associated with the interaction with service 180 and database application 182. For example, user interface 120 may present search terms to be searched by database application 182 and any results from the search.

FIG. 1B depicts a flowchart for calling a service using metadata consistent with aspects of an embodiment of the present invention. Referring to FIGS. 1A and 1B, when client system 110 or user interface 120 makes a call to service 180, client 110 and/or user interface 120 may determine metadata reflecting aspects of user interface 120 (step 192). The term “metadata” refers to data about data. For example, a library card catalog could be considered metadata because it is data about the publications in the library. Although any type of metadata may be used, in some embodiment consistent with the present invention, metadata reflecting aspects of user interface 120. The metadata may also reflect aspects of user interface 120 associated with the presentation of response information from service 180. For example, metadata may reflect aspects of the user interface, such as data reflecting that any responsive information from service 180 would be displayed in windows 122a and 122b. A window represents a portion, such as a rectangular portion, of the information being presented by user interface 120 and displayed on a computer screen.

Client system 110 may then format a message request, such as a message requesting a search at service 180. The formatted message may include the determined metadata from step 192. Client system 110 may provide the message request 112 to service 180, such that message request 112 includes metadata 136 (step 194). Metadata 136, which was determined in step 192, may reflect aspects of user interface 120 corresponding to the presentation of information responsive to request message 112. Service 180 may then process request message 112 based on metadata 136, which may enable service 180 to adapt its processing of request message 112. Client 110 may then receive from service 180 a response message 130 to the message request 112 (step 196). The response message 130 may include the responsive information 122c-d adapted by service 180 in accordance with metadata 136.

For example, request message 112 may correspond to a search request for all sales orders having a customer identification number at database application 182. The metadata 136 may describe that user interface 120 would be able to present at windows 122a and 122b responsive information for two sales orders received from service 180. Based on the metadata 136, service 180 may adapt the search by retrieving only two sales orders instead of all sales orders having the customer identification number. Alternatively, service 180 may retrieve all the orders (e.g., 122c-n) having the customer identification number, but only provide client 110 a response with two sales orders. FIG. 1A thus depicts response message 130 including a first response information (e.g., “Text C” 122c)and a second responsive information (e.g., “TEXT D” 122d), which would subsequently be presented at windows 122a-b. The use of metadata allows service 180 to adapt by, for example, not searching for, retrieving, and/or sending responsive information to the request that would not be presented by user interface 120. Moreover, by sending metadata 136 to service 180, the request message 112 including metadata 136 may eliminate a later request (not shown) by service 180 for data describing aspects of user interface 120, which may eliminate an additional roundtrip of messages between service 180 and client 110.

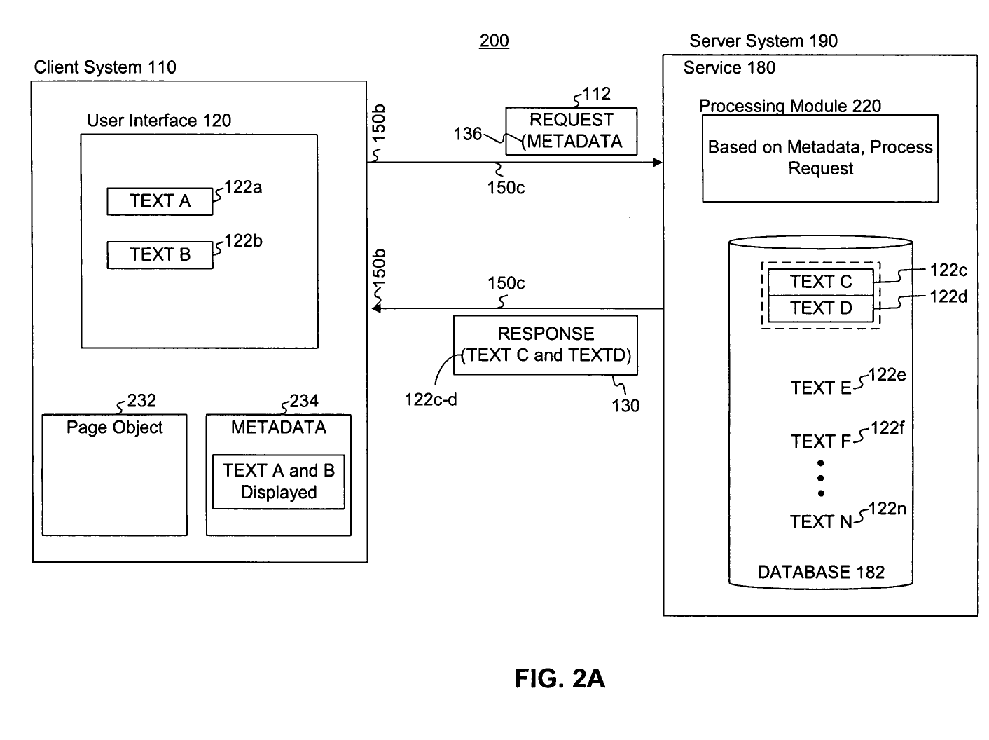

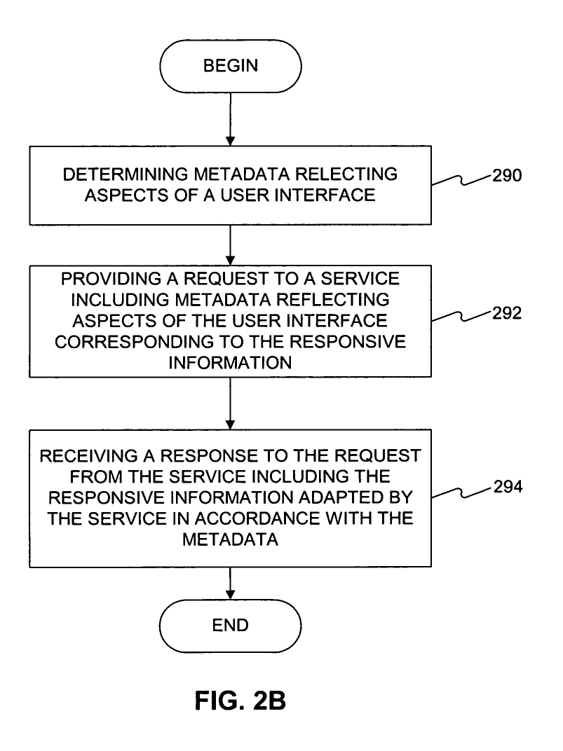

FIG. 2A depicts a block diagram of another exemplary system 200 environment that includes client system 110 and server system 190 including service 180. System 200 is similar to system 100 in many respects but includes additional features as described below. Referring to FIG. 2A, client system 110 further includes a page 232 and a metadata module 234. Service 180 further includes a processing module 220.

The page 232 may be implemented as a markup language, such as HTML. The page 232 may be used to generate a page for presentation by user interface 120. For example, user interface 120 may be implemented as a Web browser capable of presenting page 232 consisting of a markup language, such as Hyper Text Markup Language (HTML). In some embodiments, page 232 or portions of page 232 may be provided by a portal or portlets at service 180.

Metadata module 234 may be implemented as an application or service that can be called by client system 110 for generating metadata 136, reflecting aspects of user interface 120. For example, page 232 may include an HTML page for presentation by user interface 120. Since page 232 includes an HTML page with HTML tags describing the information to be presented by user interface 120, metadata module 234 may use page 232 to generate metadata describing aspects of the presentation by user interface 120 (see, e.g., “TEXT A and B Displayed” at FIG. 2A). The metadata generated by metadata module 234 may reflect, for example, that only two windows 122a-b are used to present responsive information from service 180. Moreover, the generated metadata may indicate that the two windows 122a-b present text associated with two sales orders. The generated metadata may then be used in request message 112. Although HTML is described, other forms of metadata may be used including, for example, XML (extensible Markup Language) or WML (Wireless Markup Language). Moreover, markup languages, such as XML, HTML, and WML, are examples of metadata since they allow the creation of tags that describe data being presented in a browser.

Network connections 150a-b may include, alone or in any suitable combination, a telephony-based network, a local area network (LAN), a wide area network (WAN), a dedicated intranet, wireless LAN, the Internet, an intranet, a wireless network, a bus, or any other communication mechanisms. In some implementations, network connections 150a-b are implemented as one network or link. Further, any suitable combination of wired and/or wireless components and systems may provide network connections 150a-b. Moreover, network connections 150a-b may be embodied using bidirectional, unidirectional, or dedicated communication links. Network connections 150a-b may also implement standard transmission protocols, such as Transmission Control Protocol/Internet Protocol (TCP/IP), Hyper Text Transfer Protocol (HTTP), SOAP, RPC (Remote Procedure Call), or other protocols.

Server system 190 and/or service 180 may be implemented at one or more computers, such as servers. In some embodiments, service 180 may be implemented as a portal including portlets, each of which retrieves content in response to a request from client system 110. Moreover, service 180 may allow a user at user interface 120 to interact with service 180 (or an application or Web service at service 180) and then provide responsive information to user interface 120. For example, service 180 may provide responsive information, such as a sales order form. A user at user interface 120 may interact (e.g., view, edit, update, create, delete, and the like) with the sales order form. Moreover, portions of the sales order form may be presented by user interface 120. Service 180 may also include a processing module 220, which may be called by service 180 to perform various functions including, for example, processing request messages, such as request message 112 and/or calling an application, such as calling database application 182 to initiate a search.

System 200 may be implemented as part of an enterprise services framework (ESF). An enterprise services framework is a type of computer framework, such as a client-server architectural framework, that includes one or more services. The services are accessible to other parts of the ESF, such as client systems and their corresponding users, through a communication mechanism such as the Internet or an intranet. The ESF may be constructed using tools provided by SAP Netweaver™ (commercially available from SAP AG, Walldorf, Germany). Although FIG. 2A shows a single client system 110 and a single server 190, a plurality of client systems and server systems may be used. Moreover, although only a single application and a single service 180 are depicted at FIG. 2A, a plurality of applications and services may be implemented as well. Furthermore, the components depicted in FIG. 2A may be distributed among multiple locations. Although FIG. 2A is described with respect to a client-server architecture and an ESF, system 200 can also use any other architecture or framework.

FIG. 2B depicts another flowchart for calling a service 180 using metadata consistent with aspects of an embodiment of the present invention. Referring to FIGS. 2A and 2B, to determine metadata, metadata module 234 may retrieve metadata from page 232 (step 290). The retrieved metadata may reflect aspects of user interface 120 and, in particular, reflect aspects of user interface 120, that are used to present responsive information from service 180. For example, metadata module 234 may determine that Text A 122a and Text B 122b are presented at user interface 120 by examining the HTML code including the HTML tags.

Client system 110 may then format a message request and provide the formatted request message 112 including metadata 136 (step 292). Metadata 136 may, for example, indicate that user interface 120 may only present in windows 122a-b two sales orders identified in a response from the search of database application 182. Processing module 220 at service 180 may then process request message 112 in accordance with metadata 136. The metadata 136 may enable service 180 to adapt its processing of request message 112.

Client 110 may then receive from service 180 a response message 130 to the message request 112 (step 294). The response message 130 may include the responsive information 122c-d adapted by service 180 in accordance with metadata 136. In the example depicted at FIG. 2A, “TEXT C and TEXT D” 122c-d are responsive information. Although the above description refers to requesting a search at a service, the request message 112 may correspond to any function available at any service. For example, if the service is implemented as a portal, such as the web site www.yahoo.com, the function may correspond to any service including, for example, e-mail, weather, stock quotes, searching, on-line shopping, and the like.

Although the example of FIG. 2A depicts “TEXT A and B” as the metadata retrieved by metadata module 234, any other appropriate type of data may be provided to service 180 as metadata. For example, metadata 136 may include metadata describing the display language, metadata describing the current page presented at user interface 120, metadata describing a current status of an item (e.g., the status of a button click) presented at user interface 120, and any other metadata, which may be used by a service or application at server system 190.

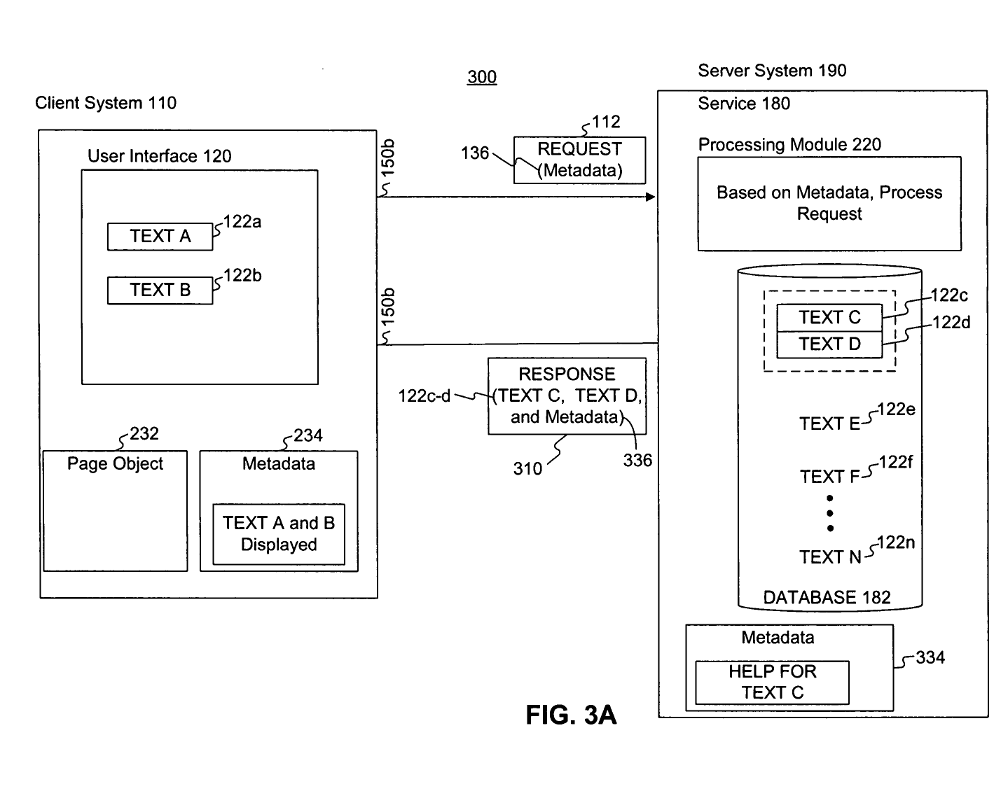

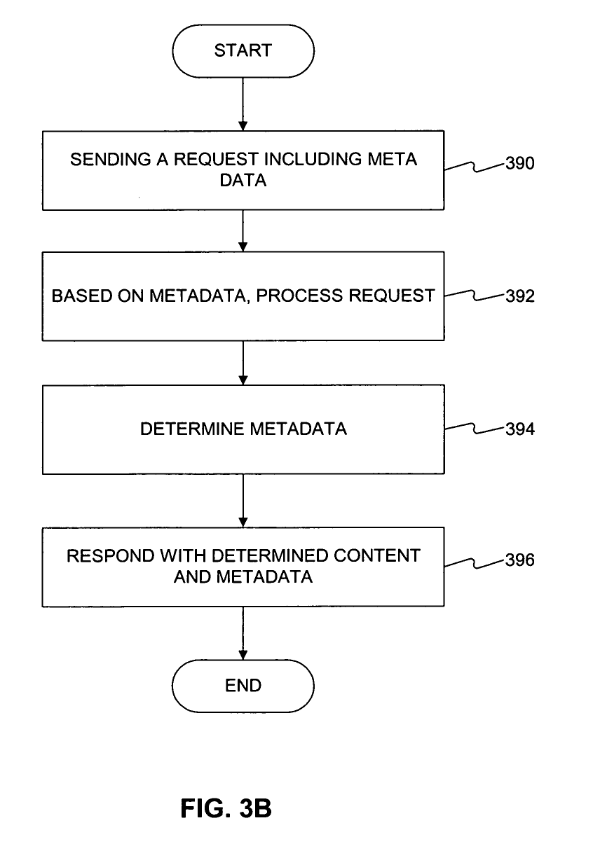

FIG. 3A depicts a block diagram of another exemplary system 300 environment consist with aspects of an embodiment of the present invention. FIG. 3A is similar to FIG. 2A in many respects. However, FIG. 3A depicts a service 180 that includes a metadata 336 in response message 310.

When a user seeks content from service 180, client system 110 calls service 180 by, for example, providing request message 112, such as sending a SOAP request message including metadata 136 as described above with respect to step 292 (step 390). The request message 112 may include a request, such as a request to perform an operation at service 180 and to receive corresponding responsive information for presentation at user interface 120. The request message 112 may also include metadata 136 describing aspects of user interface 120 corresponding to the presentation of information responsive to request message 112. Service 180 may then process the request based on metadata 136 received in the request message 112 from client 110 (step 392). As described above, the use of metadata 136 may allow service 180 to adapt how it processes the request.

Service 180 also includes a metadata module 334, which is similar in some respects to metadata module 234 but implemented at server 190. Metadata module may determine metadata 336 which is included in response message 310 to client 110 (step 394). Metadata 336 may be selected based on the application at service 180. Alternatively, metadata 336 may be determined based on the contents of request message 310 or the results included within response message 310. Metadata 336 may be in the form of a text message, such as a “HELP” information for user interface 120 or a warning message for user interface 120. Next, service 180 responds with a response message 310, such as a SOAP response message, including metadata 336 and items 122c-d for display at user interface 120 as the content of text items 122a and 122b (step 396). By providing metadata 336 in the response to client 110, client system 110 may be able to adapt its processing.

Although the example of FIG. 3A depicts text information as metadata 336, any other appropriate type of information may be included as metadata 336 in the response message 310. For example, the metadata 336 may include metadata describing that a displayed item at user interface 120 should be hidden, metadata describing that a displayed item at user interface 120 should be added (e.g., add a button, helplink, or message), and any other metadata which may be provided to client 110. Moreover, in some implementations, the metadata 336 may be used to exchange information between a portlet at service 180 and client system 110.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present invention may be implemented in various environments. For example, the above descriptions of a database application 182 and sales orders are only example since other types of applications and data may be used as well.

Moreover, environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The foregoing description is intended to illustrate but not to limit the scope of the invention, which is defined by the scope of the appended claims. Other embodiments are within the scope of the following claims.

What is claimed is:

1. A method for making a call from a user interface to a service, the method comprising:
determining metadata reflecting aspects of the user interface;
providing a request to the service including metadata reflecting aspects of the user interface corresponding to presentation of responsive information; and
receiving a response to the request from the service including the responsive information adapted in accordance with the metadata.

2. The method of claim 1, wherein determining comprises:
determining metadata based on a language describing aspects of information presented by the user interface.

3. The method of claim 1, wherein determining comprises:
determining metadata based on a markup language describing aspects of information presented by the user interface.

4. The method of claim 1, wherein determining comprises:
determining metadata based on at least one of the following: a language presented by the user interface, a page presented by the user interface, or a status of an item presented by the user interface.

5. The method of claim 1, wherein receiving comprises:
receiving the response including other metadata generated by the service.

6. The method of claim 5, comprising:
determining the other metadata based on the request.

7. The method of claim 5, comprising:
determining the other metadata based on the response.

8. The method of claim 1, wherein providing comprises:
providing the request as a Simple Object Access Protocol.

9. A computer-readable medium containing instructions to configure a processor to perform a method for making a call from a user interface to a service, the method comprising:
determining metadata reflecting aspects of the user interface;
providing a request to the service including metadata reflecting aspects of the user interface corresponding to presentation of responsive information; and
receiving a response to the request from the service including the responsive information adapted in accordance with the metadata.

10. The computer-readable medium of claim 9, wherein determining comprises:
determining metadata based on a language describing aspects of information presented by the user interface.

11. The computer-readable medium of claim 9, wherein determining comprises:
determining metadata based on a markup language describing aspects of information presented by the user interface.

12. The computer-readable medium of claim 9, wherein determining comprises:
determining metadata based on at least one of the following: a language presented by the user interface, a page presented by the user interface, or a status of an item presented by the user interface.

13. The computer-readable medium of claim 9, wherein receiving comprises:
receiving the response including other metadata generated by the service.

14. The computer-readable medium of claim 13, comprising:
determining the other metadata based on the request.

15. The computer-readable medium of claim 13, comprising:
determining the other metadata based on the response.

16. The computer-readable medium of claim 9, wherein providing comprises:
providing the request as a Simple Object Access Protocol.

17. A system for making a call to a service, the system comprising:
a processor; and
a memory, wherein the processor and the memory are configured to perform a method comprising:
determining metadata reflecting aspects of the user interface;
providing a request to the service including metadata reflecting aspects of the user interface corresponding to presentation of responsive information; and
receiving a response to the request from the service including the responsive information adapted in accordance with the metadata.

18. The system of claim 17, wherein determining comprises:
determining metadata based on a language describing aspects of information presented by the user interface.

19. The system of claim 17, wherein determining comprises:
determining metadata based on a markup language describing aspects of information presented by the user interface.

20. The system of claim 19, wherein determining comprises:
determining metadata based on at least one of the following: a language presented by the user interface, a page presented by the user interface, or a status of an item presented by the user interface.
